(19) United States
(12) Patent Application Publication
(10) Pub. No.: US 2016/0004121 A1
(43) Pub. Date: Jan. 7, 2016

(54) MODULE FOR LIQUID CRYSTAL DISPLAY APPARATUS AND LIQUID CRYSTAL DISPLAY APPARATUS COMPRISING THE SAME

(71) Applicant: SAMSUNG SDI CO., LTD., Yongin-si (KR)

(72) Inventor: Kaori Inomata, Uiwang-si (KR)

(21) Appl. No.: 14/751,111

(22) Filed: Jun. 25, 2015

(30) Foreign Application Priority Data
Jul. 3, 2014 (KR) 10-2014-0083314

(51) Int. Cl. G02F 1/1335

(52) U.S. Cl. CPC G02F 1/133528; G02F 2001/133531

(57) ABSTRACT

A module for a liquid crystal display apparatus may include: a liquid crystal display panel; first and second adhesive films on first and second surfaces of the liquid crystal display panel; first and second polarizing plates on the first and second adhesive films respectively, each polarizing plate including a polarizer and having a tetragonal shape with a long side and a short side. The absorption axes of the first polarizer and the second polarizer form an angle of about 80° to about 100°. A ratio (B/A) of the creep of the first adhesive film (B) to the creep of the second adhesive film (A) is greater than about 1 at a temperature of 25° C.

### CROSS-REFERENCE TO RELATED APPLICATION

This application claims priority to and the benefit of Korean Patent Application No. 10-2014-0083314, filed on Jul. 3, 2014, in the Korean Intellectual Property Office, the entire content of which is incorporated herein by reference.

### BACKGROUND

1. Field

One or more embodiments of the present invention relate to a module for a liquid crystal display apparatus and a liquid crystal display apparatus including the same.

2. Description of the Related Art

A liquid crystal display apparatus includes a module for the liquid crystal display apparatus and a back light unit on one side of the module to supply light. The module for the liquid crystal display apparatus includes a liquid crystal display panel and polarizing plates attached to both sides (i.e., the upper side and the lower side) of the liquid crystal display panel by adhesive films. The polarizing plates include a polarizer and a protective film on at least one side of the polarizer.

The screen of the liquid crystal display apparatus may generally have a rectangular shape having a long side and a short side, and thus the liquid crystal display panel and each of the polarizing plates attached to both sides of the liquid crystal display panel may also have a rectangular shape having a long side and a short side. When the polarizing plate attached to one surface (or side) of the liquid crystal display panel is defined as the upper polarizing plate and the polarizing plate attached to the other side of the liquid crystal display panel is defined as the lower polarizing plate, the absorption axis of the polarizer of the upper polarizing plate is perpendicular to the absorption axis of the polarizer of the lower polarizing plate. The polarizers may be prepared by uniaxial machine direction (MD) stretching for polarization. Since the upper polarizing plate and the lower polarizing plate may have different degrees of shrinkage, when the liquid crystal display apparatus is used for long periods of time or at high temperatures under severe environmental conditions, the liquid crystal display apparatus may bend toward either the upper polarizing plate or the lower polarizing plate, thereby causing non-uniformity, such as unevenness or spots on the screen. Generally, the polarizer may be prepared by uniaxially stretching a polyvinyl alcohol film to a length of about 5 times to about 6 times the initial length thereof in the MD, and since the absorption axis of the polarizer is the same as the stretching direction, the liquid crystal display apparatus may bend toward the polarizing plate with the polarizer whose absorption axis is the long side.

### SUMMARY

Aspects according to one or more embodiments of the invention are directed toward a module for a liquid crystal display apparatus and a liquid crystal display apparatus including the same.

According to one or more embodiments of the present invention, a module for a liquid crystal display apparatus may include: a liquid crystal display panel having a first surface and a second surface facing away from the first surface; a first adhesive film on the first surface of the liquid crystal display panel; a second adhesive film on the second surface of the liquid crystal display panel; a first polarizing plate on a surface of the first adhesive film, including a first polarizer and having a tetragonal shape with a long side and a short side; and a second polarizing plate on a surface of the second adhesive film, including a second polarizer and having a tetragonal shape with a long side and a short side. An absorption axis of the first polarizer is parallel to the long side of the first polarizing plate; an absorption axis of the second polarizer is parallel to the short side of the second polarizing plate; and the absorption axis of the first polarizer and the absorption axis of the second polarizer form an angle of about 80° to about 100°. A ratio (B/A) of the creep of the first adhesive film (B) to the creep of the second adhesive film (A) is greater than about 1 at a temperature of 25° C.

According to one or more embodiments of the present invention, a liquid crystal display apparatus may include the module for liquid crystal display apparatus as described above and below.

### BRIEF DESCRIPTION OF DRAWINGS

These and/or other aspects will become apparent and more readily appreciated from the following description, taken in conjunction with the accompanying drawings in which:

FIG. 1 is a cross-sectional view of a module for a liquid crystal display apparatus according to an embodiment of the present invention;

FIG. 2 is an exploded perspective view of a liquid crystal display panel and polarizers in a module for a liquid crystal display apparatus according to an embodiment of the present invention; and

FIGS. 3A-3B are schematic diagrams of the creep measurement of an adhesive film for the polarizing plates, with FIG. 3A being a front view and FIG. 3B being a side view.

### DETAILED DESCRIPTION

Certain embodiments of the present invention will be described with reference to the accompanying drawings. It should be understood that the present invention may be embodied in different ways and is not limited to the described embodiments. In the drawings, portions irrelevant to the description are omitted for clarity. Like components are denoted by like reference numerals throughout the specification. Expressions such as “at least one of,” when preceding a list of elements, modify the entire list of elements and do not modify the individual elements of the list. Further, the use of “may” when describing embodiments of the present invention refers to “one or more embodiments of the present invention.”

As used herein, directional terms such as “upper” and “lower” are defined with reference to the accompanying drawings. Thus, it will be understood that the term “upper side” may be used interchangeably with the term “lower side” when viewed from different angles. It will also be understood that when an element is referred to as being formed “on” another element, it may be formed directly on the other element, or an intervening element(s) may also be present. On the other hand, when an element is referred to as being “formed directly on” another element, intervening elements are not present.

As used herein, the term “parallel” does not necessarily mean a parallel state in a mathematical sense, and may include a substantially parallel state, i.e., may include the case where the long side of the polarizing plate and the absorption axis of the polarizer form a slight angle (e.g., an angle less than 10°) due to the manufacturing process (such as the cutting or punching process) of the polarizing plate. As used herein, the term “(meth)acrylics” may refer to acrylics and/or methacrylics.

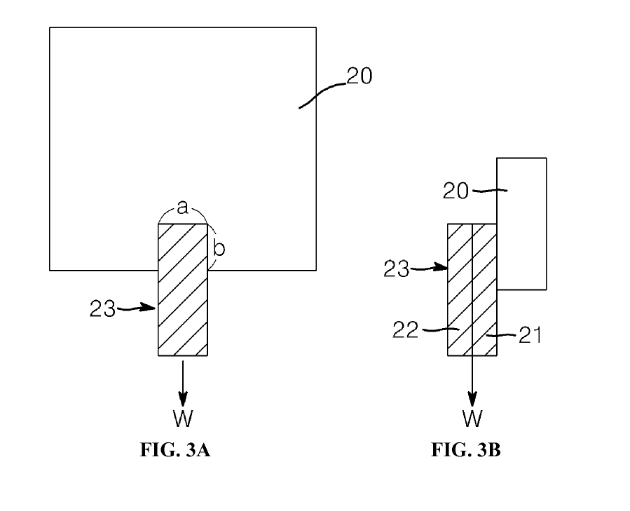

FIGS. 3A-3B are schematic diagrams of the creep measurement on an adhesive film for polarizing plates, with FIG. 3A being a front view and FIG. 3B being a side view. Referring to FIGS. 3A-3B, the term “creep” used herein refers to the distance by which a specimen 23 is pushed from a non-alkaline glass plate 20 after the specimen 23 has been attached to an area of a×b (e.g., 15 mm×15 mm) on one end of the non-alkaline glass plate 20, and the specimen 23 has been pulled at a load W for 1,000 seconds. The specimen 23 for the creep measurement includes an adhesive layer 21 (thickness: about 20 μm) and a polarizing plate 22 on the adhesive layer 21. The polarizing plate 22 includes a triacetylcellulose film, a polarizer, and another triacetylcellulose film laminated sequentially. The load W is 2,250 g when the creep measurement is conducted at a temperature of 22° C. to 25° C., and 1,500 g when the creep measurement is conducted at a temperature of 85° C. The creep may be measured using a TEXTURE ANALYZER TA.XT PLUS machine (load cell 5 kg, available from EKO Instruments Co., Ltd.). As used herein, the term “ratio of creep” may be measured at a temperature of 25° C. or 85° C.

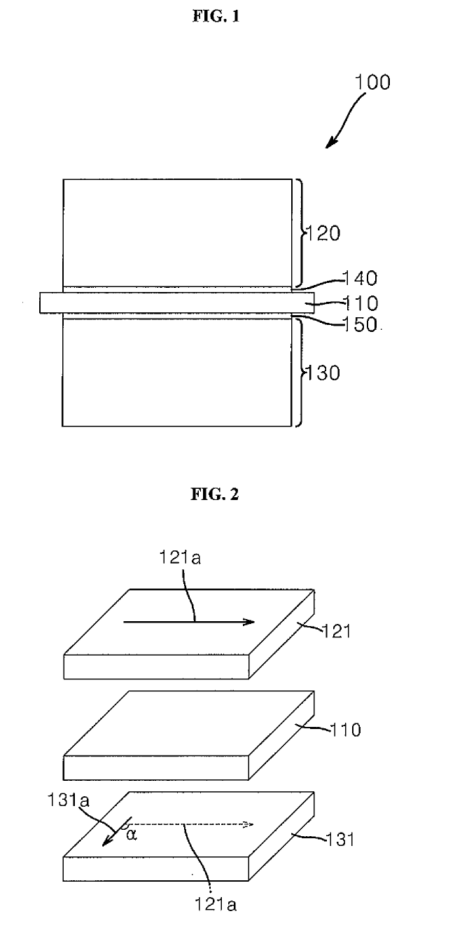

FIG. 1 is a cross-sectional view of a module for a liquid crystal display apparatus according to an embodiment of the present invention, and FIG. 2 is an exploded perspective view of a liquid crystal display panel and polarizers in a module for a liquid crystal display apparatus according to an embodiment of the present invention.

Referring to FIGS. 1 and 2, a module for a liquid crystal display apparatus 100 may include a liquid crystal display panel 110; an adhesive film 140 for a first polarizing plate 120 formed on one side of the liquid crystal display panel 110; an adhesive film 150 for a second polarizing plate 130 formed on the other side of the liquid crystal display panel 110; the first polarizing plate 120 formed on an upper surface of the adhesive film 140 for the first polarizing plate 120, including a first polarizer 121 and having a tetragonal shape with a long side and a short side; and the second polarizing plate 130 formed on a lower surface of the adhesive film 150 for the second polarizing plate, including a second polarizer 131 and having a tetragonal shape with a long side and a short side. The absorption axis 121a of the first polarizer is parallel to the long side of the first polarizing plate 120; the absorption axis 131a of the second polarizer is parallel to the short side of the second polarizing plate 130; and the absorption axis of the first polarizer and the absorption axis of the second polarizer may form an angle (a) of about 80° to about 100°. A ratio (B/A) of the creep (B) of the adhesive film 140 for the first polarizing plate to the creep (A) of the adhesive film 150 for the second polarizing plate may be greater than about 1 at a temperature of 25° C.

Because the polarizer is prepared by stretching a polyvinyl alcohol film uniaxially in a MD, the polarizer may shrink in the MD when used for a long period of time or allowed to stand at high temperatures. Therefore, the module for a liquid crystal display apparatus may bend toward the first polarizing plate, because the MD shrinkage of the first polarizer 121 may be greater than that of the second polarizer 131 when the panel for the liquid crystal display apparatus is used for a long period of time or allowed to stand at high temperatures.

According to some embodiments of the present invention, a module for a liquid crystal display apparatus includes an adhesive film 140 for the first polarizing plate and an adhesive film 150 for the second polarizing plate. A ratio (B/A) of the creep (B) of the adhesive film 140 for the first polarizing plate to the creep (A) of the adhesive film 150 for the second polarizing plate is greater than about 1 at a temperature of 25° C., and the adhesive film for the second polarizing plate has a cohesive force higher than that of the adhesive film for the first polarizing plate such that the adhesive film for the second polarizing plate may offset the degree of bending of the first polarizing plate. Therefore, it is possible to reduce or inhibit bending of the module for the liquid crystal display panel and improve the display quality (such as reduce the formation of spots). In some embodiments, the ratio (B/A) of the creep values may be about 1.01 to about 6 at a temperature of 25° C. For example, it may be about 1.1 to about 6.

The ratio (B/A) of the creep values may be greater than about 1 at a temperature of 85° C. Within this range, it is possible to reduce or inhibit the bending and avoid the formation of display spots even at high temperatures. In some embodiments, the ratio (B/A) may be about 1.01 to about 6 at 85° C. For example, it may be about 1.1 to about 3.

In FIG. 2, the angle (α) may be about 80° to about 100°. In some embodiments, the angle may be about 85° to about 95°. For example, the angle may be about 90°.

In some embodiments, the adhesive film for the first polarizing plate may have a creep of about 200 μm to about 600 μm at a temperature of 25° C., and the adhesive film for the second polarizing plate may have a creep of about 50 μm to about 400 μm at a temperature of 25° C. Within these ranges, the adhesive films may be suitable for use in the liquid crystal display apparatus such that the adhesive films may have an effect on the reduction or inhibition of bending and the formation of display spots.

In another embodiment, the adhesive film for the first polarizing plate may have a creep of about 200 μm to about 600 μm at a temperature of 85° C., and the adhesive film for the second polarizing plate may have a creep of about 50 μm to about 500 μm at a temperature of 85° C. Within these ranges, the adhesive films may be suitable for use in the liquid crystal display apparatus such that the adhesive films may have an effect on the reduction or inhibition of bending and the formation of display spots.

In one embodiment, a difference between the creep of the adhesive film for the first polarizing plate and the creep of the adhesive film for the second polarizing plate may be about 50 μm to about 300 μm, for example, about 50 μm to about 260 μm, at a temperature of 25° C. Within these ranges, the adhesive films may be suitable for use in the liquid crystal display apparatus, and the adhesive films may have an effect on the reduction or inhibition of bending and the formation of display spots.

In some embodiments, a difference between the creep of the adhesive film for the first polarizing plate and the creep of the adhesive film for the second polarizing plate may be about 40 μm to about 300 μm at a temperature of 85° C. Within this range, the adhesive films may be suitable for use in the liquid crystal display apparatus, and the adhesive films may have an effect on the reduction or inhibition of bending and the formation of display spots. In some embodiments, the difference between the creep of the adhesive film for the first polarizing plate and the creep of the adhesive film for the second polarizing plate at 85° C. may be about 40 μm to about 260 μm.

The thicknesses of the adhesive film for the first polarizing plate and the adhesive film for the second polarizing plate may be the same or different. For example, the adhesive film for the first polarizing plate and the adhesive film for the second polarizing plate may have a thickness ratio of about 1:1 to about 1:2. Within this range, and when the ratio of the creep values is within the ranges discussed above, the adhesive films may be suitable for use in the liquid crystal display apparatus, and the adhesive films may have an effect on the reduction or inhibition of bending.

A laminate of the first polarizing plate and the adhesive film for the first polarizing plate may have a tetragonal form (e.g., a rectangle), and may be the same size as a laminate of the second polarizing plate and the adhesive film for the second polarizing plate. The laminate of the first polarizing plate and the adhesive film of the first polarizing plate (and/or the laminate of the second polarizing plate and the adhesive film for the second polarizing plate) may have a ratio of a length of the long side to a length of the short side of about 1.1 or greater. Within this range, and when the ratio of the creep values is as described above, the adhesive films may be suitable for use in the liquid crystal display apparatus, and the adhesive films may have an effect on the reduction or inhibition of bending. The ratio of the length of the long side to the length of the short side may be, for example, about 1.5 to about 8.

When the ratio of the creep values is as described above, the liquid crystal display panel may have a thickness of about 500 μm to about 2500 μm, the first polarizing plate may have a thickness of about 50 μm to about 250 μm, the second polarizing plate may have a thickness of about 50 μm to about 250 μm, the adhesive film for the first polarizing plate may have a thickness of about 10 μm to about 100 μm, and the adhesive film for the second polarizing plate may have a thickness of about 10 μm to about 100 μm. Within these ranges, the adhesive films may be suitable for use in the liquid crystal display apparatus, and the adhesive films may have an effect on the suppression of bending and the formation of display spots.

According to some embodiments of the present invention, a liquid crystal display panel 110, which transmits light incident from a second polarizing plate 130 onto a first polarizing plate 120, may include a liquid crystal cell layer enclosed between a first substrate and a second substrate. In some embodiments, the first substrate may be a color filter (CF) substrate, and the second substrate may be a thin film transistor (TFT) substrate. In FIG. 1, the first substrate, the second substrate and the liquid crystal cell layer are not depicted.

The first substrate and the second substrate may be formed of the same material or different materials, and may be a glass or plastic substrate. The plastic substrate may include, for example, polyethylene terephthalate (PET), polycarbonate (PC), polyimide (PI), polyethylene naphthalate (PEN), polyethersulfone (PES), polyarylate (PAR), cycloolefin copolymer (COC) substrates and the like, which may be suitably used in flexible displays, but the plastic substrate is not limited thereto.

The liquid crystal cell layer may be a liquid crystal layer which includes liquid crystals arranged in any one of an in-plane switching (IPS) mode, a fringe field switching (FFS) mode, a twisted nematic (TN) mode, or a vertical alignment (VA) mode.

Each of the first polarizing plate 120 and the second polarizing plate 130 may be formed on the liquid crystal display panel 110 to absorb light incident upon the liquid crystal display panel and display an image. The first polarizing plate 120 may include a first polarizer and an optical film for the first polarizing plate formed on at least one side of the first polarizer, and the second polarizing plate 130 may include a second polarizer and an optical film for the second polarizing plate formed on at least one side of the second polarizer.

The first polarizer 121 and the second polarizer 131, which allow transmission of light only in a certain direction, may be prepared by dyeing a polyvinyl alcohol film with iodine or a dichroic dye, followed by stretching in a certain direction. For example, the polarizer may be prepared by swelling, dyeing, stretching, and cross-linking a polyvinyl alcohol film. Methods for performing each of these steps are generally known to those of ordinary skill in the art.

The first polarizer 121 and the second polarizer 131 may be the same or different. Each of the first polarizer 121 and the second polarizer may have a thickness of about 3 μm to about 50 μm. Within this range, and when the ratio of the creep values is as described above, the adhesive films may be suitable for use in the liquid crystal display apparatus, and the adhesive films may have an effect on the reduction or inhibition of bending.

The optical film for the first polarizing plate and the optical film for the second polarizing plate, which may be a non-phase difference film (i.e., a film that does not cause any significant phase change in the light), may be formed on one or both sides of the first polarizer, and on one or both sides of the second polarizer, respectively, to protect the first polarizer and the second polarizer, respectively.

The optical film for the first polarizing plate and the optical film for the second polarizing plate (which may be optically transparent optical films) may be made of at least one of a cellulose, such as triacetyl cellulose or the like; a polyester, such as polyethylene terephthalate, polybutylene terephthalate, polyethylene naphthalate, polybutylene naphthalate or the like; a cyclic polyolefin; a polycarbonate; a polyethersulfone; a polysulfone; a polyamides a polyimide; a polyolefin; a polyarylate; a polyvinyl alcohol; a polyvinyl chloride; or a polyvinylidene chloride resin. The film may be prepared using a single resin or a combination of two or more resins. For example, the optical film for the first polarizing plate and the optical film for the second polarizing plate may be prepared by using the same or different resins.

The optical film for the first polarizing plate and the optical film for the second polarizing plate may be bonded to the first polarizer and the second polarizer, respectively, using any suitable adhesive for the polarizing plates. In some embodiments, the adhesive for the polarizing plates may include at least one of a polyvinyl alcohol adhesive or a photo-curable adhesive, but the adhesive is not limited thereto.

The adhesive film for the first polarizing plate 140 and the adhesive film for the second polarizing plate 150 (which are used to attach the first polarizing plate and the second polarizing plate to the liquid crystal display panel) may have a ratio (B/A) of the creep values of greater than about 1, for example, about 1.1 to about 6, at a temperature of 25° C.; and greater than about 1, for example, about 1.1 to about 3, at a temperature of 85° C. Within these ranges, it is possible to reduce or inhibit bending and reduce or minimize the formation of display spots.

The adhesive film for the first polarizing plate and the adhesive film for the second polarizing plate may be prepared using the same or different adhesives. Nonlimiting examples of suitable adhesives may include, for example, (meth)acrylic adhesives including (meth)acrylic resins, silicone adhesives including silicone resins, urethane adhesives including urethane resins, and the like.

In some embodiments, the adhesive film for the first polarizing plate and the adhesive film for the second polarizing plate may be respectively prepared using an adhesive composition including a (meth)acrylic resin and a curing agent to improve the processability of the module for the liquid crystal display apparatus and to enhance adhesive force to the liquid crystal display panel. The adhesive film for the first polarizing plate and the adhesive film for the second polarizing plate may achieve the ratio of the creep values discussed above by adjusting the amount of the curing agent and the weight average molecular weight of the (meth)acrylic resin and the like in the adhesive composition.

In some embodiments, the adhesive film for the first polarizing plate and the adhesive film for the second polarizing plate may be respectively prepared using an adhesive composition including the (meth)acrylic resin and the curing agent. The (meth)acrylic resin in each adhesive composition for the adhesive film for the first polarizing plate and the adhesive film for the second polarizing plate may be the same and may be used in the same amount in the adhesive composition. A ratio of the amount of the curing agent in the adhesive composition for the second polarizing plate to the amount of the curing agent in the adhesive composition for the first polarizing plate may be greater than about 1. Within this range, the adhesive films may have the ratio of the creep values as described above, such that the adhesive films may have an effect on the reduction or inhibition of bending and the formation of display spots. For example, the ratio of the amount of the curing agent in the adhesive composition for the second polarizing plate to the amount of the curing agent in the adhesive composition for the first polarizing plate may be about 1.1 to about 200. For example, the ratio of the amount of the curing agent in the adhesive composition for the second polarizing plate to the amount of the curing agent in the adhesive composition for the first polarizing plate may be about 1.2 to about 120.

In some embodiments, the adhesive composition for the first polarizing plate may include 100 parts by weight of the (meth)acrylic resin and about 0.01 parts by weight to about 5 parts by weight of the curing agent based on solids content, and the adhesive composition for the second polarizing plate may include 100 parts by weight of the (meth)acrylic resin and about 0.01 parts by weight to about 6 parts by weight of the curing agent based on the solids content. A ratio of the amount of the curing agent in the adhesive composition for the second polarizing plate to the amount of the curing agent in the adhesive composition for the first polarizing plate may be greater than about 1. For example, the ratio of the amount of the curing agent in the adhesive composition for the second polarizing plate to the amount of the curing agent in the adhesive composition for the first polarizing plate may be about 1.1 to about 200.

In some embodiments, the adhesive film for the first polarizing plate and the adhesive film for the second polarizing plate may be respectively prepared using an adhesive composition including a (meth)acrylic resin and a curing agent, the curing agent in each of the adhesive compositions for the adhesive film for the first polarizing plate and the adhesive film for the second polarizing plate may be the same and may be used in the same amounts in the adhesive composition. In some embodiments, the (meth)acrylic resin in the adhesive composition for the first polarizing plate may have a weight average molecular weight of about 1,500,000 g/mol or less, for example, about 800,000 g/mol to about 1,400,000 g/mol. The (meth)acrylic resin in the adhesive composition for the second polarizing plate may have a weight average molecular weight of about 1,500,000 g/mol or greater, for example, about 1,500,000 g/mol to about 2,500,000 g/mol, or about 1,500,000 g/mol to about 2,000,000 g/mol. Within these ranges, the adhesive films may have the ratio of the creep values discussed above, such that the adhesive films may have an effect on the reduction or inhibition of bending and the formation of display spots. The (meth)acrylic resin in each adhesive composition for the adhesive film for the first polarizing plate and the adhesive film for the second polarizing plate may be used in the same or different amount in the adhesive compositions. For example, the amount of (meth)acrylic resin in each adhesive composition may be the same.

In some embodiments, the adhesive composition for the first polarizing plate may include 100 parts by weight of the (meth)acrylic resin having a weight average molecular weight of about 800,000 g/mol to about 1,400,000 g/mol, and about 0.01 parts by weight to about 5 parts by weight of the curing agent based on the solids content. The adhesive composition for the second polarizing plate may include 100 parts by weight of the (meth)acrylic resin having a weight average molecular weight of about 1,500,000 g/mol to about 2,000,000 g/mol, and about 0.01 parts by weight to about 5 parts by weight of the curing agent based on the solids content. Within these ranges, the adhesive films may have the ratio of the creep values discussed above, such that the adhesive films may have an effect on the inhibition or reduction of bending and the formation of display spots.

Next, the components of an adhesive composition for the polarizing plates according to some embodiments of the present invention will be described.

A (meth)acrylic resin may be cured to form a matrix of the adhesive film, and may be polymerized from at least one of a (meth)acrylic monomer having an alkyl group, a (meth)acrylic monomer having a hydroxyl group, a (meth)acrylic monomer having an alicyclic group, a (meth)acrylic monomer having a heteroalicyclic group, a (meth)acrylic monomer having an aromatic group and/or a (meth)acrylic monomer having a carboxylic acid group. The (meth)acrylic resin may be prepared by polymerizing a monomer mixture including, for example, 100 parts by weight of a (meth)acrylic monomer having an alkyl group, and about 0.1 parts by weight to about 10 parts by weight of a (meth)acrylic monomer having a hydroxyl group.

The (meth)acrylic monomer having an alkyl group may include a (meth)acrylic acid ester having an unsubstituted C₁ to C₂₀ alkyl group. For example, the (meth)acrylic monomer having an alkyl group may include at least one of methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, 2-ethylhexyl (meth)acrylate, heptyl (meth)acrylate, octyl (meth)acrylate, iso-octyl (meth)acrylate, nonyl (meth)acrylate, decyl (meth)acrylate, and/or dodecyl (meth)acrylate. A single (meth)acrylic monomer having an alkyl group may be used, or or a combination of two or more (meth)acrylic monomers having an alkyl group may be used.

The (meth)acrylic monomer having an alkyl group may be present in an amount of about 80 wt % to about 99.99 wt %, for example, about 80 wt % to about 99 wt %, or about 90 wt % to about 99 wt %, based on a total weight of the monomer mixture.

The (meth)acrylic monomer having a hydroxyl group may include a (meth)acrylic acid ester having a substituent that contains the hydroxyl group, where the substituent can include a C₂ to C₂₀ alkyl group, a C₅ to C₂₀ cycloalkyl group, or a C₆ to C₂₀ aryl group. The (meth)acrylic monomer having a hydroxyl group may include, for example, at least one of 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1,4-cyclohexanedimethanol mono(meth)acrylate, 1-chloro-2-hydroxypropyl (meth)acrylate, diethylene gylcol mono(meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexane dimethanol mono(meth)acrylate. A single (meth)acrylic monomer having a hydroxyl group may be used, or a combination of two or more (meth)acrylic monomers having a hydroxyl group may be used.

The (meth)acrylic monomer having a hydroxyl group may be present in an amount of about 0.01 wt % to about 20 wt %, for example, about 0.1 wt % to about 20 wt %, or about 1 wt % to about 10 wt %, based on a total weight of the monomer mixture.

The (meth)acrylic monomer having an alicyclic group may include a (meth)acrylic acid ester having a C₃ to C₁₀ alicyclic group, for example, at least one of isobornyl (meth)acrylate and/or cyclohexyl (meth)acrylate. A single (meth)acrylic monomer having an alicyclic group may be used or a combination of two or more (meth)acrylic monomers having an alicyclic group may be used.

The (meth)acrylic monomer having an alicyclic group may be used in an amount of about 0 wt % to about 20 wt % based on a total weight of the monomer mixture.

The (meth)acrylic monomer having a heteroalicyclic group may include a (meth)acrylic acid ester having a C₂ to C₁₀ alicyclic group having at least one heteroatom (e.g., at least one of N, O and S). For example, the (meth)acrylic monomer having a heteroalicyclic group may be (meth)acryloylmorpholine, but the (meth)acrylic monomer having a heteroalicyclic group is not limited thereto.

The (meth)acrylic monomer having a heteroalicyclic group may be present in an amount of about 0 wt % to about 20 wt % based on a total weight of the monomer mixture.

The (meth)acrylic monomer having an aromatic group may include a monomer represented by Formula 1, but the (meth)acrylic monomer having an aromatic group is not limited thereto:

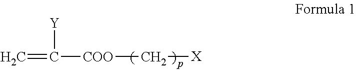

In Formula 1, Y is a hydrogen atom or a methyl group; p is an integer of 0 to 10; and X is at least one of a phenoxy group, a phenyl group, a methylphenyl group, a methylethylphenyl group, a methoxyphenyl group, a propylphenyl group, a cyclohexylphenyl group, a chlorophenyl group, a bromophenyl group, a phenylphenyl group, a benzyl group and/or a benzylphenyl group.

The (meth)acrylic monomer having an aromatic group may include the monomer represented by Formula 1. A single (meth)acrylic monomer having an aromatic group may be used or a combination of two or more (meth)acrylic monomers having an aromatic group may be used. The (meth)acrylic monomer having an aromatic group may be present in an amount of about 0 wt % to about 20 wt % based on a total weight of the monomer mixture.

The (meth)acrylic monomer having a carboxylic acid group may include at least one of (meth)acrylic acid and/or β-carboxyethyl (meth)acrylate, but the (meth)acrylic monomer having a carboxylic acid group is not limited thereto. A single (meth)acrylic monomer having a carboxylic acid group may be used or a combination of two or more (meth)acrylic monomers having a carboxylic acid group may be used. The (meth)acrylic monomer having a carboxylic acid group may be present in an amount of about 0 wt % to about 20 wt % based on a total weight of the monomer mixture.

The (meth)acrylic resin may be prepared by adding a suitable polymerization initiator (for example, azobisdimethylvaleronitrile or the like) to the monomer mixture and polymerizing the mixture for about 1 hour to about 10 hours at about 50° C. to about 100° C. The weight average molecular weight of the (meth)acrylic resin may be adjusted by controlling polymerization parameters, such as the polymerization temperature, the polymerization time, and the like.

The curing agent may include any suitable curing agent, such as those known to those of ordinary skill in the art. For example, at least one of an isocyanate curing agent, an epoxy curing agent and/or a metal chelate curing agent may be used.

The isocyanate curing agent may be a bifunctional or trifunctional curing agent. A single isocyanate curing agent may be used or a combination of two or more isocyanate curing agents may be used. The isocyanate curing agent may be, for example, hexamethylene diisocyanate (HDI); a toluene diisocyanate (TDI) including 2,4-toluene diisocyanate, 2,6-toluene diisocyanate or the like; 4,4′-methylenediphenyl diisocyanate (MDI); a xylene diisocyanate (XDI) including 1,3-xylene diisocyanate, 1,4-xylene diisocyanate or the like; hydrogenated toluene diisocyanate; isophorone diisocyanate; 1,3-bisisocyanatomethylcyclohexane, tetramethylxylene diisocyanate; 1,5-naphtalene diisocyanate; 2,2,4-trimethylhexamethylene diisocyanate; 2,4,4-trimethylhexamethylene diisocyanate; a trimethylolpropane toluene diisocyanate adduct including an adduct of trimethylolpropane/toluene diisocyanate trimer; a xylene diisocyanate adduct of trimethylolpropane; triphenylmethane triisocyanate; methylenebis triisocyanate, or the like, but the isocyanate curing agent is not limited thereto. A single isocyanate curing agent may be used or a combination of two or more isocyanate curing agents may be used.

In some embodiments, when a mixture of a bifunctional isocyanate curing agent and a trifunctional isocyanate curing agent is used for the adhesive film for the second polarizing plate, a weight ratio of the bifunctional isocyanate curing agent to the trifunctional isocyanate curing agent in the mixture may be about 1:10 to about 1:400. Within this range, the adhesive film may have the ratio of the creep values as discussed above, such that the adhesive films may have an effect on the reduction or inhibition of bending.

The metal chelate curing agent may be a material that increases the crosslinking rate, and nonlimiting examples thereof include coordination compounds of acetylacetone, acetoacetylester, or the like that include a metal selected from aluminum, iron, copper, zinc, tin, titanium, nickel, antimony, magnesium, vanadium, chromium, zirconium, etc.

The adhesive composition for the first polarizing plate and the adhesive composition for the second polarizing plate according to embodiments of the present invention may each further include a silane coupling agent. Any suitable silane coupling agent may be used as the silane coupling agent, which may increase adhesive force to the liquid crystal display panel. The silane coupling agent may include, for example, at least one of: a silicon compound having an epoxy structure, such as 3-glycidoxypropyl trimethoxysilane, 3-glycidoxypropyl methyldimethoxysilane, 2-(3,4-epoxycyclohexyl) ethyltrimethoxysilane or the like; a polymerizable unsaturated group-containing silicon compound, such as vinyl trimethoxysilane, vinyl triethoxysilane, (meth)acryloxypropyl trimethoxysilane or the like; an amino group-containing silicon compound, such as 3-aminopropyl trimethoxysilane, N-(2-aminoethyl)-3-aminopropyl trimethoxysilane, N-(2-aminoethyl)-3-aminopropyl methyl dimethoxysilane or the like; and/or 3-chloropropyl trimethoxysilane, but the silane coupling agent is not limited thereto.

In some embodiments, the silane coupling agent may be present in an amount of about 0.01 parts by weight to about 5 parts by weight based on the solids content and based on 100 parts by weight of the (meth)acrylic resin. Within this range, it is possible to achieve good adhesive force to the liquid crystal display panel. In some embodiments, the silane coupling agent may be present in an amount of about 0.01, 0.02, 0.03, 0.04, 0.05, 0.06, 0.07, 0.08, 0.09, 0.1, 0.2, 0.3, 0.4, 0.5, 1, 2, 3, 4, or 5 parts by weight based on 100 parts by weight of the (meth)acrylic resin.

Each of the adhesive film 140 for the first polarizing plate and the adhesive film 150 for the second polarizing plate may be prepared by coating the adhesive composition for the respective polarizing plate as described above to a desired thickness and aging the coating at about 20° C. to about 50° C. for about 1 day to about 7 days.

A liquid crystal display according to some embodiments of the present invention may include the module for a liquid crystal display apparatus described above. For example, the liquid crystal display may include a module for a liquid crystal display apparatus described above and a back light unit formed on the module for a liquid crystal display apparatus.

Hereinafter, certain embodiments of the present invention will be described with reference to some examples. It should be understood that these examples are provided for illustration purposes only and are not to be construed in any way as limiting the present invention.

### Preparative Example 1

In a reactor provided with a thermometer, a stirrer, a nitrogen inlet tube and a reflux condenser, 100 parts by weight of n-butylacrylate, 2 parts by weight of 2-hydroxyethylacrylate, 90 parts by weight of ethyl acetate, and 0.3 parts by weight of azobisdimethylvaleronitrile were added, and the resulting mixture was allowed to reach a temperature of 60° C. in the reactor purged with nitrogen and polymerized for 8 hours. After completion of the polymerization reaction, the mixture was adjusted with ethyl acetate so that the solids content in the mixture became 15.0% to prepare an acrylate adhesive resin. Next, 100 parts by weight of the prepared acrylate adhesive resin, 0.04 parts by weight of a curing agent (CORONATE L, Nippon Polyurethane Industry Co., Ltd., an adduct of trimethylolpropane/toluene diisocyanate trimer, trifunctional isocyanate), 0.06 parts by weight of a silane coupling agent (KBM403, Shin-Etsu Chemical Co., Ltd.) and 20 parts by weight of ethyl acetate as a solvent were introduced into the reactor, followed by stirring, thereby preparing an adhesive composition.

The adhesive composition was coated onto a polyethylene terephthalate film and dried to a thickness of about 20 μm, followed by aging under 55% relative humidity (RH) at a temperature of 25° C. for one week, thereby preparing an adhesive film. In the meantime, a polarizing plate 22 was prepared by sequentially laminating a triacetylcellulose film, a PVA polarizer and a triacetylcellulose film. The creep value of the adhesive film was measured as shown in FIG. 3. Referring to FIG. 3, a specimen 23, which is a laminate of the polarizing plate 22 and the adhesive film 21 (thickness: 20 μm), was cut to a size of 15 mm×50 mm. The laminate was then laminated on a non-alkaline glass plate (a non-alkaline soda glass) 20 to a laminate area of 15 mm×15 mm. Then, a TEXTURE ANALYZER TA.XT Plus device (a load cell of 5 kg; EKO Instruments, Co., Ltd.) was used to measure the creep of the specimen 23. The creep value of the specimen 23 was 328 μm when maintained at a constant temperature of 22° C. under a load of 2,250 g for 1,000 seconds. In addition, the creep value of the specimen 23 was 432 μm when maintained at a constant temperature of 85° C. under a load of 1,500 g for 1,000 seconds.

### Preparative Examples 2 to 3

Each of the adhesive compositions of Preparative Examples 2 to 3 was prepared and evaluated for the creep value as in Preparative Example 1, except that the amount of the curing agent (CORONATE L) in Preparative Example 1 was changed as shown in Table 1 below.

### Preparative Example 4

An adhesive composition was prepared and evaluated for the creep value as in Preparative Example 1, except that 0.02 parts by weight of CORONATE L and 5 parts by weight of BXX-6460 (Toyo Ink Manufacturing Co., Ltd., a bifunctional isocyanate curing agent, containing a long-chain alkyl group) were used as the curing agent.

### Preparative Example 5

Into a reactor provided with a thermometer, a stirrer, a nitrogen inlet tube and a reflux condenser, 100 parts by weight of n-butylacrylate, 2 parts by weight of 2-hydroxyethylacrylate, 90 parts by weight of ethyl acetate, and 0.3 parts by weight of azobisdimethylvaleronitrile were added, and the resulting mixture was allowed to reach a temperature of 55° C. in the reactor purged with nitrogen and polymerized for 10 hours. After the completion of the polymerization reaction, the mixture was adjusted with ethyl acetate so that the solids content in the mixture became 15.0% to prepare an acrylate adhesive resin. Next, 100 parts by weight of the prepared acrylate adhesive resin, 0.02 parts by weight of a curing agent (CORONATE L, Nippon Polyurethane Industry Co., Ltd.), 0.06 parts by weight of a silane coupling agent (KBM403, Shin-Etsu Chemical Co., Ltd.) and 20 parts by weight of ethyl acetate as a solvent were introduced into the reactor, followed by stirring, thereby preparing an adhesive composition. An adhesive film was prepared and evaluated for the creep value as in Preparative Example 1.

### Preparative Example 6

An adhesive composition was prepared and evaluated for the creep value as in Preparative Example 1, except that the amount of the curing agent (CORONATE L) in Preparative Example 5 was changed as shown in Table 1 below.

TABLE 1

| | | Preparative Examples | | | | | |
|---|---|---|---|---|---|---|---|
| | | 1 | 2 | 3 | 4 | 5 | 6 |
| (Meth)acrylate adhesive | | 100 | 100 | 100 | 100 | 100 | 100 |
| resin | | | | | | | |
| (part by weight) | | | | | | | |
| Weight average molecular | | 1.3 × 10⁶ | 1.3 × 10⁶ | 1.3 × 10⁶ | 1.3 × 10⁶ | 1.5 × 10⁶ | 1.5 × 10⁶ |
| weight of (meth)acrylate | | | | | | | |
| adhesive resin | | | | | | | |
| (Mw, g/mol) | | | | | | | |
| Solvent (part by weight) | | 20 | 20 | 20 | 20 | 20 | 20 |
| Curing agent | CORONATEL | 0.04 | 0.05 | 0.06 | 0.02 | 0.02 | 0.04 |
| (part by | BXX-6460 | — | — | — | 5 | — | — |
| weight) | | | | | | | |
| Silane | KBM403 | 0.06 | 0.06 | 0.06 | 0.06 | 0.06 | 0.06 |
| coupling | | | | | | | |
| agent (part | | | | | | | |
| by weight) | | | | | | | |
| Creep (μm) | at 25° C. | 328 | 247 | 160 | 100 | 380 | 270 |
| | at 85° C. | 432 | 356 | 270 | 250 | 476 | 355 |

### Example 1

### (1) Preparation of a Polarizer

A polyvinyl alcohol film (Kuraray Co., Ltd., Japan) was swollen in water at 35° C. for 10 min, stretched to 3 times its initial length at 60° C., followed by adsorption of iodine. Next, the resulting film was stretched again to 2.5 times its previous length in a boric acid solution at 40° C., thereby preparing a polarizer.

### (2) Preparation of an Adhesive Film

The adhesive composition of each of Preparative Examples 1 and 3 was coated onto a polyethylene terephthalate film and dried to a thickness of 20 μm, thereby preparing an adhesive film.

### (3) Preparation of a Laminate of the First Polarizing Plate and the Adhesive Film for the First Polarizing Plate

A TAC film (thickness: 20 μm, KC2CT1W, Konica Minolta, Inc.) was laminated on one side of the above prepared polarizer using an adhesive for the polarizing plate (Z-320, Nippon Synthetic Chemical Industry, Co., Ltd.), and the adhesive film prepared according to Preparative Example 1 was laminated on the other side of the prepared polarizer, followed by aging at a temperature of 25° C. for one week. The resulting laminate was then punched (cut) to a rectangular form (shape) with a long side and a short side, so that the absorption axis of the polarizer was the long side (i.e., parallel to the long side), thereby preparing a laminate (long side: 150 mm, short side: 90 mm, thickness: 72 μm) of the first polarizing plate and the adhesive film for the first polarizing plate.

### (4) Preparation of a Laminate of the Second Polarizing Plate and the Adhesive Film for the Second Polarizing Plate

A TAC film (thickness: 20 μm, KC2CT1W, Konica Minolta, Inc.) was laminated on one side of the above prepared polarizer using an adhesive for the polarizing plate (Z-320, Nippon Synthetic Chemical Industry, Co., Ltd.), and the adhesive film prepared from Preparative Example 3 was laminated on the other side of the prepared polarizer, followed by aging at a temperature of 25° C. for one week. The resulting laminate was then punched (cut) to a rectangular form (shape) with a long side and a short side, so that the absorption axis of the polarizer was the short side (i.e., parallel to the short side), thereby preparing a laminate (long side: 150 mm, short side: 90 mm, thickness: 72 μm) of the second polarizing plate and the adhesive film for the second polarizing plate.

### (5) Preparation of a Module

The laminates prepared as above were attached to opposite sides of a glass substrate (Samsung Corning Precision Materials Co., Ltd., EAGLEXG, thickness: 0.5 mm, long side: 160 cm, short side: 100 cm), so that the absorption axis of the polarizer for the first polarizing plate was perpendicular to the absorption axis of the polarizer for the second polarizing plate, thereby preparing a module for a liquid crystal display apparatus. The glass substrate was then replaced with a liquid crystal display panel.

### Examples 2 to 6

A module for a liquid crystal display apparatus was prepared as in Example 1, except that the adhesive film for the first polarizing plate and the adhesive film for the second polarizing plate in Example 1 were changed as shown in Table 2 below.

### Comparative Examples 1 to 5

A module for a liquid crystal display apparatus according to each of Comparative Examples 1 to 5 was prepared as in Example 1, except that the adhesive film for the first polarizing plate and the adhesive film for the second polarizing plate in Example 1 were changed as shown in Table 3 below.

The first polarizing plate, the second polarizing plate, the adhesive film and the module for a liquid crystal display apparatus according to Examples 1-6 and Comparative Examples 1-5 were evaluated as to their physical properties (such as, bending value, formation of display spots, reliability, and the like) as follows. The results thereof are shown in Tables 2 and 3 below.

(1) Bending value: The polarizing plate bonded to the adhesive film was cut to a size of 150 mm×90 mm, and laminated on an upper surface and a lower surface of a non-alkaline glass substrate having a size of 160 mm×100 mm so that the absorption axis of the polarizer of the upper surface had an angle of 180° (or 0°) with respect to the width (the width direction) of the non-alkaline glass, and the absorption axis of the polarizer of the lower surface had an angle of 90° with respect to the width of the non-alkaline glass. The specimen prepared as above was allowed to stand in a thermostat at 85° C. for 48 hours, and then allowed to stand at 25° C. for one hour to determine the bending value. The bending value was determined by putting the specimen on a planar work bench with the upper surface of the non-alkaline glass facing upwards, and measuring the highest distance from the work bench to the upper side of the polarizer using a Digital Height Gage (Mitutoyo Corporation). Among the measured values, a maximum value and a minimum value were obtained.

(2) Display spots: The polarizing plate bonded to the adhesive film was cut to a size of 150 mm×90 mm, and laminated on an upper surface and a lower surface of a non-alkaline glass substrate having a size of 160 mm×100 mm so that the absorption axis of the polarizer of the upper surface had an angle of 180° (or 0°) with respect to the width (the width direction) of the non-alkaline glass, and the absorption axis of the polarizer of the lower surface had an angle of 90° with respect to the width (the width direction) of the non-alkaline glass. The specimen prepared as above was allowed to stand in a thermostat at 85° C. for 98 hours, and then allowed to stand at 25° C. for one hour, and mounted on a back light to observe the display spots with the naked eye. The obtained liquid crystal display apparatus was evaluated as “∘” when a bending light leak or a light leak was not observed at all with the naked eye, as “Δ” when a slight bending light leak or a slight light leak was observed with the naked eye, and as “x” when a significant bending light leak or a significant light leak was observed with the naked eye.

(3) Reliability: The polarizing plate bonded to the adhesive film was cut to a size of 150 mm×90 mm, and laminated on an upper surface and a lower surface of a non-alkaline glass substrate having a size of 160 mm×100 mm so that the absorption axis of the polarizer of the upper surface had an angle of 180° (or 0°) with respect to the width (the width direction) of the non-alkaline glass, and the absorption axis of the polarizer of the lower surface had an angle of 90° with respect to the width (the width direction) of the non-alkaline glass. The specimen prepared as above was allowed to stand in a thermostat at 85° C. for 96 hours, and then allowed to stand at 25° C. for one hour to observe the detachment of the adhesive film, the generation of foam, and the like, which were observed with the naked eye. The obtained module for a liquid crystal display apparatus was evaluated as “∘” when no detachment of the adhesive film or no generation of foam was observed with the naked eye, and as “x” when a detachment of the adhesive film or some generation of foam was observed with the naked eye.

TABLE 2

| | | Examples | | | | | |
|---|---|---|---|---|---|---|---|
| | | 1 | 2 | 3 | 4 | 5 | 6 |
| Adhesive film for the | | Prep. | Prep. | Prep. | Prep. | Prep. | Prep. |
| first polarizing plate | | Example 1 | Example 1 | Example 2 | Example 5 | Example 5 | Example 1 |
| Adhesive film for the | | Prep. | Prep. | Prep. | Prep. | Prep. | Prep. |
| second polarizing | | Example 3 | Example 2 | Example 4 | Example 6 | Example 1 | Example 6 |
| plate | | | | | | | |
| Creep | at 25° C. | 2.05 | 1.33 | 2.47 | 1.41 | 1.16 | 1.21 |
| ratio* | at 85° C. | 1.60 | 1.21 | 1.42 | 1.34 | 1.10 | 1.21 |
| Bending | Max. | 0.45 | 0.46 | 0.55 | 0.46 | 0.44 | 0.43 |
| value | value | | | | | | |
| (mm) | Min. | 0 | 0 | 0 | 0 | 0 | 0 |
| | value | | | | | | |
| | Max. | 0.45 | 0.46 | 0.55 | 0.46 | 0.44 | 0.43 |
| | value − | | | | | | |
| | Min. | | | | | | |
| | value | | | | | | |
| Display | Bending | ∘ | ∘ | ∘ | ∘ | ∘ | ∘ |
| spot | light leak | | | | | | |
| | Light leak | ∘ | ∘ | ∘ | ∘ | ∘ | ∘ |

| | | | | | | |
|---|---|---|---|---|---|---|
| Reliability | ∘ | ∘ | ∘ | ∘ | ∘ | ∘ |

TABLE 3

| | | Comparative Examples | | | | |
|---|---|---|---|---|---|---|
| | | 1 | 2 | 3 | 4 | 5 |
| Adhesive film for the | | Prep. | Prep. | Prep. | Prep. | Prep. |
| first polarizing plate | | Example 4 | Example 4 | Example 2 | Example 6 | Example 6 |
| Adhesive film for the | | Prep. | Prep. | Prep. | Prep. | Prep. |
| second polarizing plate | | Example 4 | Example 1 | Example 1 | Example 5 | Example 1 |
| Creep | at 25° C. | 1.00 | 0.30 | 0.75 | 0.71 | 0.82 |
| ratio* | at 85° C. | 1.00 | 0.58 | 0.82 | 0.75 | 0.82 |
| Bending | Max. value | 1.12 | 0.97 | 0.97 | 0.74 | 0.75 |
| value | Min. value | 0 | 0 | 0 | 0 | 0 |
| (mm) | Max. value − | 1.12 | 0.97 | 0.97 | 0.74 | 0.75 |
| | Min. value | | | | | |
| Display | Bending | x | Δ | Δ | Δ | Δ |
| spot | light leak | | | | | |
| | Light leak | x | x | x | Δ | Δ |

| | | | | | |
|---|---|---|---|---|---|
| Reliability | ∘ | ∘ | ∘ | ∘ | ∘ |

* Creep ratio: ratio of the creep of the adhesive film for the first polarizing plate to the creep of the adhesive film for the second polarizing plate

As shown in Tables 2 and 3, it was demonstrated that the modules for a liquid crystal display apparatus according to embodiments of the present invention had low bending values and good high temperature reliability, and did not exhibit any display spots. In contrast, the modules of Comparative Examples 1-5 had high bending values and poor reliability, and exhibited display spots. For example, the module according to Comparative Example 1 used adhesive films with low creep value (see Table 1) and high cohesive force such that the possibility of bending increased.

While certain exemplary embodiments of the present invention have been illustrated and described, those of ordinary skill in the art will understand that various modifications, changes, alterations, and equivalent embodiments can be made without departing from the spirit and scope of the invention, as described in the following claims, and equivalents thereof.

What is claimed is:

1. A module for a liquid crystal display apparatus, comprising:
a liquid crystal display panel;
a first adhesive film on a first surface of the liquid crystal display panel;
a second adhesive film on a second surface of the liquid crystal display panel;
a first polarizing plate on a surface of the first adhesive film, the first polarizing plate comprising a first polarizer and having a tetragonal shape with a long side and a short side; and
a second polarizing plate on a surface of the second adhesive film, the second polarizing plate comprising a second polarizer and having a tetragonal shape with a long side and a short side,
wherein:
an absorption axis of the first polarizer is parallel to the long side of the first polarizing plate,
an absorption axis of the second polarizer is parallel to the short side of the second polarizing plate,
the absorption axis of the first polarizer and the absorption axis of the second polarizer form an angle of about 80° to about 100°, and
a ratio (B/A) of a creep of the first adhesive film (B) to a creep of the second adhesive film (A) is greater than about 1 at a temperature of 25° C.

2. The module for a liquid crystal display apparatus according to claim 1, wherein the ratio (B/A) is about 1.1 to about 6 at a temperature of 25° C.

3. The module for a liquid crystal display apparatus according to claim 1, wherein the ratio (B/A) is greater than about 1 at a temperature of 85° C.

4. The module for a liquid crystal display apparatus according to claim 1, wherein the ratio (B/A) is about 1.1 to about 3 at a temperature of 85° C.

5. The module for a liquid crystal display apparatus according to claim 1, wherein a difference between the creep of the first adhesive film and the creep of the second adhesive film is about 50 μm to about 300 μm at a temperature of 25° C.

6. The module for a liquid crystal display apparatus according to claim 1, wherein the creep of the first adhesive film is about 200 μm to about 600 μm at a temperature of 25° C., and the creep of the second adhesive film is about 50 μm to about 400 μm at a temperature of 25° C.

7. The module for a liquid crystal display apparatus according to claim 1, wherein the first and second adhesive films are each independently formed of an adhesive composition comprising a (meth)acrylic resin and a curing agent.

8. The module for a liquid crystal display apparatus according to claim 7, wherein a ratio of an amount of the curing agent in the adhesive composition for the second adhesive film to an amount of the curing agent in the adhesive composition for the first adhesive film is greater than about 1.

9. The module for a liquid crystal display apparatus according to claim 7, wherein the (meth)acrylic resin in the adhesive composition for the first adhesive film has a weight average molecular weight of less than about 1,500,000 g/mol, and the (meth)acrylic resin in the adhesive composition for the second adhesive film has a weight average molecular weight of about 1,500,000 g/mol or greater.

10. The module for a liquid crystal display apparatus according to claim 7, wherein the (meth)acrylic resin comprises a copolymer of a monomer mixture comprising 100 parts by weight of a (meth)acrylic monomer having an alkyl group and about 0.1 parts by weight to about 10 parts by weight of a (meth)acrylic monomer having a hydroxyl group.

11. The module for a liquid crystal display apparatus according to claim 7, wherein the curing agent comprises at least one of a bifunctional isocyanate curing agent or a trifunctional isocyanate curing agent.

12. The module for a liquid crystal display apparatus according to claim 7, wherein the adhesive composition further comprises about 0.01 parts by weight to about 5 parts by weight of a silane coupling agent.

13. A liquid crystal display apparatus comprising the module for a liquid crystal display apparatus according to claim 1.
